(19) United States
(12) Patent Application Publication
(10) Pub. No.: US 2026/0164374 A1
(43) Pub. Date: Jun. 11, 2026

(54) TECHNIQUES FOR USER EQUIPMENT (UE) REPORTING OF HYPER- FRAME NUMBER (HFN) DESYNCHRONIZATION

(71) Applicant: QUALCOMM Incorporated, San Diego, CA (US)

(72) Inventors: Sherif ELAZZOUNI, San Diego, CA (US); Arun Prasanth BALASUBRAMANIAN, San Diego, CA (US); Arnaud MEYLAN, San Diego, CA (US); Soo Bum LEE, San Diego, CA (US); Ozcan OZTURK, San Diego, CA (US)

(21) Appl. No.: 18/976,034

(22) Filed: Dec. 10, 2024

(51) Int. Cl. H04W 56/00; H04W 72/231; H04W 76/30

(52) U.S. Cl. CPC H04W 56/001; H04W 72/231; H04W 76/30

(57) ABSTRACT

Methods, systems, and devices for wireless communications are described. In some cases, a user equipment (UE) may receive configuration indicative of one or more trigger events for which the UE is to report hyper-frame number (HFN) desynchronization between the UE and a network entity. For example, the configuration information may indicate a threshold quantity of instances of HFN desynchronization such that satisfaction of the one or more trigger events is based on a quantity of instances of HFN desynchronization detected by the UE satisfying the threshold quantity of instances of HFN desynchronization. Thus, the UE may transmit, in accordance with the configuration information, a report indicative of HFN desynchronization based on satisfaction of the one or more trigger events.

### FIELD OF TECHNOLOGY

The following relates to wireless communications, including techniques for user equipment (UE) reporting of hyper-frame number (HFN) desynchronization.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving configuration information indicative of one or more trigger events for which the UE is to report hyper-frame number (HFN) desynchronization between the UE and a network entity and transmitting, in accordance with the configuration information, a report indicative of HFN desynchronization based on satisfaction of the one or more trigger events.

A UE for wireless communications is described. The UE may include one or more memories storing processor executable code, and one or more processors coupled with the one or more memories. The one or more processors may individually or collectively be operable to execute the code to cause the UE to receive configuration information indicative of one or more trigger events for which the UE is to report HFN desynchronization between the UE and a network entity and transmit, in accordance with the configuration information, a report indicative of HFN desynchronization based on satisfaction of the one or more trigger events.

Another UE for wireless communications is described. The UE may include means for receiving configuration information indicative of one or more trigger events for which the UE is to report HFN desynchronization between the UE and a network entity and means for transmitting, in accordance with the configuration information, a report indicative of HFN desynchronization based on satisfaction of the one or more trigger events.

A non-transitory computer-readable medium storing code for wireless communications is described. The code may include instructions executable by one or more processors to receive configuration information indicative of one or more trigger events for which the UE is to report HFN desynchronization between the UE and a network entity and transmit, in accordance with the configuration information, a report indicative of HFN desynchronization based on satisfaction of the one or more trigger events.

In some examples of the method, UEs, and non-transitory computer-readable medium described herein, the configuration information may be indicative of a threshold quantity of instances of HFN desynchronization and satisfaction of the one or more trigger events may be based on a quantity of instances of HFN desynchronization detected by the UE satisfying the threshold quantity of instances of HFN desynchronization.

In some examples of the method, UEs, and non-transitory computer-readable medium described herein, the threshold quantity of instances of HFN desynchronization includes a threshold quantity of consecutive instances of HFN desynchronization or a threshold quantity of instances of HFN desynchronization relative to a total quantity of packet data units (PDUs).

In some examples of the method, UEs, and non-transitory computer-readable medium described herein, transmitting the report may include operations, features, means, or instructions for transmitting the report based on expiration of a timer, where the timer may be started based on satisfaction of the one or more trigger events.

In some examples of the method, UEs, and non-transitory computer-readable medium described herein, the configuration information includes an indication of a duration of the timer.

In some examples of the method, UEs, and non-transitory computer-readable medium described herein, the report includes an indication of a quantity of instances of HFN desynchronization, a bearer identifier associated with the HFN desynchronization, a respective sequence number (SN) associated with each instance of HFN desynchronization from the quantity of instances of HFN desynchronization, a respective counter value associated with each instance of HFN desynchronization from the quantity of instances of HFN desynchronization, a counter value associated with a last successful instance of HFN synchronization prior to reporting of the HFN desynchronization, or any combination thereof.

In some examples of the method, UEs, and non-transitory computer-readable medium described herein, transmitting the report may include operations, features, means, or instructions for transmitting the report via the first communication link based on the HFN desynchronization being associated with the first radio link control (RLC) entity.

In some examples of the method, UEs, and non-transitory computer-readable medium described herein, the report includes an indication of an identifier associated with the first RLC entity, a respective SN associated with each instance of HFN desynchronization, or both.

Some examples of the method, UEs, and non-transitory computer-readable medium described herein may further include operations, features, means, or instructions for releasing the first communication link based on transmission of the report.

Some examples of the method, UEs, and non-transitory computer-readable medium described herein may further include operations, features, means, or instructions for declaring radio link failure (RLF based on the HFN desynchronization, where declaring RLF includes transmission of the report.

In some examples of the method, UEs, and non-transitory computer-readable medium described herein, the report may be transmitted via a radio resource control (RRC) message, via a medium access control control element (MACE-CE) message, via a packet data convergence protocol control (PDCP) message, or any combination thereof.

A method for wireless communications by a network entity is described. The method may include transmitting configuration information indicative of one or more trigger events for which a UE is to report HFN desynchronization between the UE and the network entity and receiving, in accordance with the configuration information, a report indicative of HFN desynchronization.

A network entity for wireless communications is described. The network entity may include one or more memories storing processor executable code, and one or more processors coupled with the one or more memories. The one or more processors may individually or collectively be operable to execute the code to cause the network entity to transmit configuration information indicative of one or more trigger events for which a UE is to report HFN desynchronization between the UE and the network entity and receive, in accordance with the configuration information, a report indicative of HFN desynchronization.

Another network entity for wireless communications is described. The network entity may include means for transmitting configuration information indicative of one or more trigger events for which a UE is to report HFN desynchronization between the UE and the network entity and means for receiving, in accordance with the configuration information, a report indicative of HFN desynchronization.

A non-transitory computer-readable medium storing code for wireless communications is described. The code may include instructions executable by one or more processors to transmit configuration information indicative of one or more trigger events for which a UE is to report HFN desynchronization between the UE and the network entity and receive, in accordance with the configuration information, a report indicative of HFN desynchronization.

In some examples of the method, network entities, and non-transitory computer-readable medium described herein, the configuration information may be indicative of a threshold quantity of instances of HFN desynchronization and the one or more trigger events include a quantity of instances of HFN desynchronization detected by the UE satisfying the threshold quantity of instances of HFN desynchronization.

In some examples of the method, network entities, and non-transitory computer-readable medium described herein, the threshold quantity of instances of HFN desynchronization includes a threshold quantity of consecutive instances of HFN desynchronization or a threshold quantity of instances of HFN desynchronization relative to a total quantity of PDUs.

In some examples of the method, network entities, and non-transitory computer-readable medium described herein, the configuration information includes an indication of a duration of a timer.

In some examples of the method, network entities, and non-transitory computer-readable medium described herein, the report includes an indication of a quantity of instances of HFN desynchronization, a bearer identifier associated with the HFN desynchronization, a respective SN associated with each instance of HFN desynchronization from the quantity of instances of HFN desynchronization, a respective counter value associated with each instance of HFN desynchronization from the quantity of instances of HFN desynchronization, a counter value associated with a last successful instance of HFN synchronization prior to reporting of the HFN desynchronization, or any combination thereof.

In some examples of the method, network entities, and non-transitory computer-readable medium described herein, the network entity may be associated with a first RLC entity and a second radio link control entity, where the first RLC entity is associated with a first communication link, and where the second RLC is associated with a second communication link. In such cases, the report may be received via the first communication link based on the HFN desynchronization being associated with the first RLC entity.

In some examples of the method, network entities, and non-transitory computer-readable medium described herein, the report includes an indication of an identifier associated with the first RLC entity, a respective SN associated with each instance of HFN desynchronization, or both.

Some examples of the method, network entities, and non-transitory computer-readable medium described herein may further include operations, features, means, or instructions for releasing the first communication link based on reception of the report.

Some examples of the method, network entities, and non-transitory computer-readable medium described herein, the report may include an indication of RLF.

In some examples of the method, network entities, and non-transitory computer-readable medium described herein, the report may be received via an RRC message, via a MAC-CE message, via a PDCP message,, or any combination thereof.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for user equipment (UE) reporting of hyper-frame number (HFN) desynchronization in accordance with one or more aspects of the present disclosure.

FIG. 2 shows an example of a wireless communications system that supports techniques for UE reporting of HFN desynchronization in accordance with one or more aspects of the present disclosure.

FIG. 3 shows an example of a process flow that supports techniques for UE reporting of HFN desynchronization in accordance with one or more aspects of the present disclosure.

FIGS. 4 and 5 show block diagrams of devices that support techniques for UE reporting of HFN desynchronization in accordance with one or more aspects of the present disclosure.

FIG. 6 shows a block diagram of a communications manager that supports techniques for UE reporting of HFN desynchronization in accordance with one or more aspects of the present disclosure.

FIG. 7 shows a diagram of a system including a device that supports techniques for UE reporting of HFN desynchronization in accordance with one or more aspects of the present disclosure.

FIGS. 8 and 9 show block diagrams of devices that support techniques for UE reporting of HFN desynchronization in accordance with one or more aspects of the present disclosure.

FIG. 10 shows a block diagram of a communications manager that supports techniques for UE reporting of HFN desynchronization in accordance with one or more aspects of the present disclosure.

FIG. 11 shows a diagram of a system including a device that supports techniques for UE reporting of HFN desynchronization in accordance with one or more aspects of the present disclosure.

FIGS. 12 and 13 show flowcharts illustrating methods that support techniques for UE reporting of HFN desynchronization in accordance with one or more aspects of the present disclosure.

### DETAILED DESCRIPTION

In some wireless communications systems, a network entity may transmit, to a user equipment (UE), packet data units (PDUs) in accordance with a packet data convergence protocol (PDCP), which may be referred to as PDCP PDUs, where each PDCP PDU is associated with a sequence number (SN) and a hyper-frame number (HFN). In such cases, each PDCP PDU may include a header indicating a respective value of an SN associated with the PDCP PDU, and a value of a respective HFN associated with each PDCP PDU may be based on a count of SNs maintained by each device (e.g., each of the UE and the network entity). In other words, the network entity may increment values of SNs of subsequent PDCP PDUs in a set of PDCP PDUs and when a threshold (e.g., maximum) SN value is reached, a value of the HFN may increase by one for a next set of PDCP PDUs. As such, each of the UE and the network entity may separately determine (e.g., track, count) a value of the HFN for each PDCP PDU.

Additionally, each of the UE and the network entity may maintain a respective counter (e.g., COUNT) associated with PDCP PDUs, where a value of each counter for each PDCP PDU is based on a value of the SN associated with the PDCP PDU, as indicated via the PDCP PDU, and a value of the HFN associated with the PDCP PDU, as determined by a respective device (e.g., the UE or the network entity). However, in some cases, a value of a counter of the UE, which may be referred to as the UE counter, may differ from a value of a counter of the network entity, which may be referred to as the network entity counter, for a same PDCP PDU. The difference between the UE counter and the network entity counter may be based on a value of the HFN associated with the PDCP data PDU differing between the UE and the network entity. That is, for a first PDCP PDU, a value of the UE counter may be based on a first value of the SN associated with the first PDCP PDU (e.g., as indicated via the first PDCP PDU) and a first value of the HFN associated with the first PDCP, as determined by the UE, but a value of the network entity counter may be based on the first value of the SN associated with the first PDCP PDU (e.g., as indicated via the first PDCP PDU) and a second value of the HFN associated with the first PDCP, as determined by the network entity, where the first value of the HFN is different than the second value of the HFN. In other words, the UE and the network entity may determine different values of the HFN associated with a PDCP PDU, which may be referred to as HFN desynchronization. In such cases, the UE may not be able to decipher the PDCP PDU based on the difference in values of the HFN. That is, ciphering of the PDCP PDU by the network entity may be based on a value of the network entity counter and deciphering of the PDCP PDU by the UE may be based on a value of the UE counter, such that when the value of the network entity counter used to cipher the PDCP PDU differs from the value of the UE counter used to decipher the PDCP PDU (e.g., due to HFN desynchronization), the UE may not be able to decipher the PDCP. In such cases, the UE may discard the PDCP PDU based on failure to decipher the PDCP PDU. Additionally, the network entity may not be aware of HFN desynchronization, such that the network entity may continue to send PDCP PDUs that the UE may not be capable of deciphering and may continue to discard, resulting in service interruptions.

Accordingly, techniques described herein may enable a UE to report HFN desynchronization to a network entity. For example, the UE may receive, from the network entity, configuration information indicating one or more trigger events associated with reporting of HFN desynchronization. For example, the configuration information may indicate a threshold quantity of HFN desynchronization instances such that the UE may transmit a report indicating HFN desynchronization based on a quantity of HFN desynchronization instances detected by the UE satisfying (e.g., meeting or exceeding) the threshold quantity of HFN desynchronization instances. In some cases, the threshold quantity of HFN desynchronization instances may include a threshold quantity of consecutive HFN desynchronization instances or a threshold quantity of HFN desynchronization instances (e.g., consecutive or not) relative to a total quantity of received PDCP PDUs (e.g., deciphering attempts). Additionally, or alternatively, the report may indicate the quantity of HFN desynchronization instances, a bearer identifier (ID) associated with the HFN desynchronization, a respective SN associated with each HFN desynchronization instance (e.g., associated with each PDCP PDU for which deciphering fails), a respective value of the UE counter associated with each HFN desynchronization instance, a value of the UE counter associated with a last correctly received (e.g., and deciphered) PDCP PDU, or any combination thereof.

Aspects of the disclosure are initially described in the context of wireless communications systems. Aspects are then described in the context of a process flow. Aspects of the disclosure are further illustrated by and described with reference to apparatus diagrams, system diagrams, and flowcharts that relate to techniques for UE reporting of HFN desynchronization.

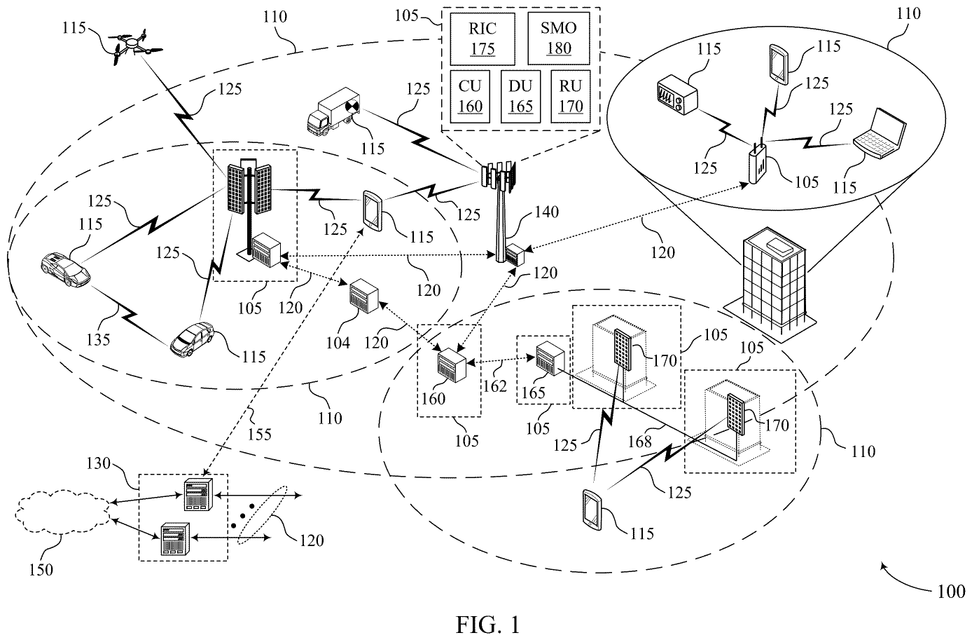

FIG. 1 shows an example of a wireless communications system 100 that supports techniques for UE reporting of HFN desynchronization in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support techniques for UE reporting of HFN desynchronization as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a UE 115 of the wireless communications system 100 may report HFN desynchronization to a network entity 105. For example, the UE 115 may receive, from the network entity 105, configuration information indicating one or more trigger events associated with reporting of HFN desynchronization. For example, the configuration information may indicate a threshold quantity of HFN desynchronization instances such that the UE may transmit a report indicating HFN desynchronization based on a quantity of HFN desynchronization instances detected by the UE 115 satisfying (e.g., meeting or exceeding) the threshold quantity of HFN desynchronization instances. In some cases, the threshold quantity of HFN desynchronization instances may include a threshold quantity of consecutive HFN desynchronization instances or a threshold quantity of HFN desynchronization instances (e.g., consecutive or not) relative to a total quantity of PDCP PDUs. Additionally, or alternatively, the report may indicate the quantity of HFN desynchronization instances, a bearer ID associated with the HFN desynchronization, a respective SN associated with each HFN desynchronization instance (e.g., associated with each PDCP PDU for which deciphering fails), a respective value of a UE counter associated with each HFN desynchronization instance, a value of a UE counter associated with a last correctly received (e.g., and deciphered) PDCP PDU, or any combination thereof.

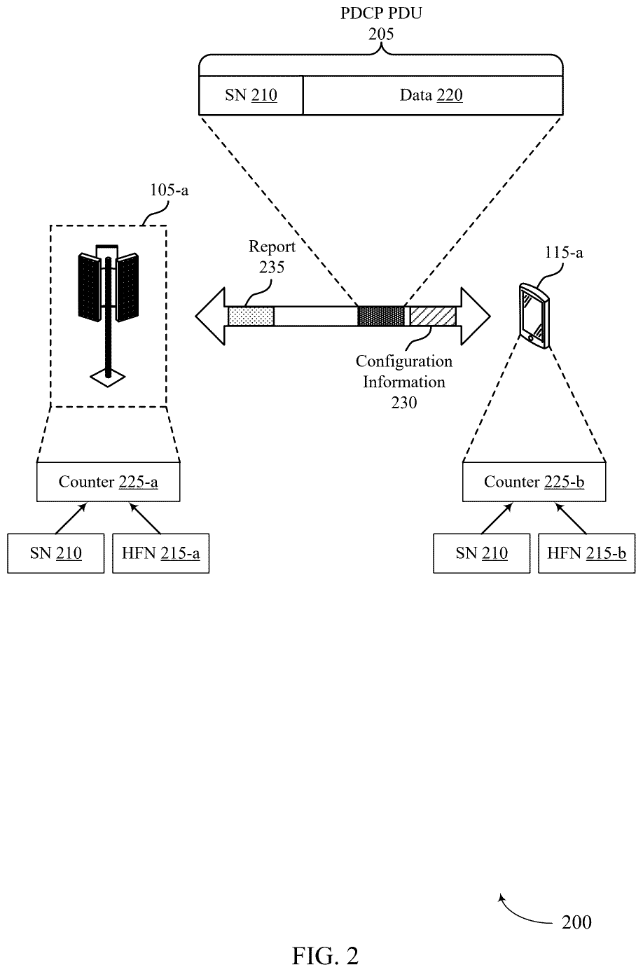

FIG. 2 shows an example of a wireless communications system 200 that supports techniques for UE reporting of HFN desynchronization in accordance with one or more aspects of the present disclosure. In some cases, the wireless communications system 200 may implement or be implemented by aspects of the wireless communications system 100. For example, the wireless communications system 200 may include one or more UEs 115 (e.g., a UE 115-a) and one or more network entities 105 (e.g., a network entity 105-a), which may be examples of the corresponding devices as described herein.

In some wireless communications systems, such as the wireless communications system 200, a network entity 105, such as the network entity 105-a, may transmit, to a UE 115, such as the UE 115-a, PDUs in accordance with a PDCP, which may be referred to as PDCP PDUs 205, where each PDCP PDU 205 is associated with an SN 210 (e.g., a value of an SN 210) and an HFN 215 (e.g., a value of an HFN 215). As described herein, the term “an SN 210” may refer to a value of an SN 210 and the term “an HFN 215” may refer to a value of an HFN 215. In such cases, each PDCP PDU 205 may include a header indicating a respective SN 210 associated with the PDCP PDU 205 (e.g., and may include data 220), and a value of a respective HFN 215 associated with each PDCP PDU 205 may be based on a count of SNs 210 maintained by each device (e.g., each of the UE 115-a and the network entity 105-a). In other words, the network entity 105 may increment SNs 210 of subsequent PDCP PDUs 205 in a set of PDCP PDUs 205 and when a threshold (e.g., maximum) SN 210 is reached, an HFN 215 may increase by one for a next set of PDCP PDUs 205. For example, each PDCP PDU 205 in a first set of PDCP PDUs 205 may be associated with an HFN 215 of 1 and respective SNs 210 of PDCP PDUs 205 in the first set of PDCP PDUs 205 may increment from 000 (e.g., for a first PDCP PDU 205 in the first set of PDCP PDUs 205) to 111 (e.g., for a last PDCP PDU 205 in the first set of PDCP PDUs 205). Thus, after the SN 210 of 111 is used (e.g., after the last PDCP PDU 205 in the first set of PDCP PDU 205), the HFN 215 may increase from 1 to 2 for a second set of PDCP PDUs 205 and respective SNs 210 for the second set of PDCP PDUs 205 may reset incrementing from 000. As such, each of the UE 115-a and the network entity 105-a may separately determine (e.g., track, count) the HFN 215 for each PDCP PDU 205.

Additionally, each of the UE 115-a and the network entity 105-a may maintain a respective counter 225 (e.g., COUNT) associated with PDCP PDUs 205, where a value of each counter 225 for each PDCP PDU 205 is based on the SN 210 associated with the PDCP PDU 205 (e.g., as indicated via the PDCP PDU 205) and the HFN 215 associated with the PDCP PDU 205 (e.g., as determined by each device). However, in some cases, a value of a counter 225 of the UE 115-a, or a counter 225-b (e.g., UE counter), may differ from a value of a counter 225 of the network entity 105-a, or a counter 225-a (e.g., network entity counter), for a same PDCP PDU 205 based on the HFN 215 associated with the PDCP PDU 205 differing between the UE 115-a and the network entity 105-a.

For example, as depicted in FIG. 2, the network entity 105-a may transmit a PDCP PDU 205 to the UE 115-a, where the PDCP PDU 205 indicates at least the SN 210 and data 220. As such, a value of the counter 225-a for the PDCP PDU 205 may be based on the SN 210 and an HFN 215-a associated with the PDCP PDU 205, as identified by the network entity 105-a. However, a value of the counter 225-b for the PDCP PDU 205 may be based on the SN 210 and an HFN 215-b, as determined by the UE 115-a, where the HFN 215-a is different than the HFN 215-b. In other words, the value of the counter 225-a may be different than the value of the counter 225-b based on the network entity 105-a and the UE 115-a determining different HFNs 215 for the same PDCP PDU 205, which may be referred to as HFN desynchronization.

In such cases, the UE 115-a may not be able to decipher the PDCP PDU 205 (e.g., without integrity protection, with integrity protection) based on the HFN 215-a being different than the HFN 215-b (e.g., based on the value of the counter 225-a being different than the value of the counter 225-b). That is, ciphering of the PDCP PDU 205 by the network entity 105-a may be based on the value of the counter 225-a and deciphering of the PDCP PDU 205 by the UE 115-a may be based on the value of the counter 225-b, such that when the value of the counter 225-a differs from the value of the counter 225-b based on HFN desynchronization, the deciphering by the UE 115-a may fail. In some cases, the UE 115-a may detect HFN desynchronization based on failure to decipher the PDCP PDU 205. That is, verification of an HFN 215 (e.g., by the UE 115-a) may include deciphering an associated PDCP PDU 205 with a candidate key, where the candidate key is based on an associated HFN 215, and verifying a first byte in the PDCP PDU 205 (e.g., an IP header), such that when deciphering fails (e.g., based on using a candidate key that is based on a different HFN 215 than used by the network entity 105-a to cipher the PDCP PDU 205), the UE 115-a may not be able to verify the first byte. In such cases, the UE 115-a may discard the PDCP PDU 205.

Additionally, the network entity 105-a may not be aware of HFN desynchronization, such that the network entity 105-a may continue to send PDCP PDUs 205 that the UE 115-a may not be able to successfully decipher and may continue to discard, resulting in service interruptions. That is, data 220 (e.g., from each PDCP PDU 205) may be discarded by the UE 115-a (e.g., by a modem of the UE 115-a) and may not be copied to a host (e.g., of the UE 115-a), such that the UE 115-a may not be able to recover the data 220 after discarding (e.g., such that the data 220 is lost for an application). For example, in some cases (e.g., at high downlink rates), a demback at the UE 115-a may perform processing of a PDCP PDU 205 and may write ciphertext to an IP accelerator (e.g., of the UE 115-a) without writing a copy of the ciphertext to the modem of the UE 115-a. However, as previously mentioned, if deciphering fails at the IP accelerator, the PDCP PDU 205 may be discarded by the IP accelerator without an ability to retry deciphering (e.g., due to no copy of the ciphertext at the modem).

In some cases, to resolve HFN desynchronization, the demback at the UE 115-a may process the PDCP PDU 205 and may write ciphertext to the modem, the modem may copy the ciphertext, and may write the ciphertext and a first candidate key, based on a first HFN 215, to the IP accelerator. In such cases, if deciphering fails, the IP accelerator may indicate the failure to the modem and the modem may write the ciphertext and a second candidate key based on a second HFN 215 to the IP accelerator, where the second HFN 215 is 1 greater or 1 less than the first HFN 215. If deciphering is successful based on the second HFN 215, the IP accelerator may indicate the success to the modem and the modem may delete the copy of the ciphertext. Additionally, the IP accelerator many write plain text to the host. In some other cases, if deciphering fails again, the IP accelerator may indicate the failure to the modem and the modem may write the ciphertext and a third candidate key based on a third HFN 215 to the IP accelerator, where the third HFN 215 is 1 greater than the first HFN 215 if the second HFN 215 was 1 less than the first HFN 215, or is 1 less than the first HFN 215 if the second HFN 215 was 1 greater than the first HFN 215. However, this may result in increased latency due to multiple deciphering attempts, resulting in service interruptions. Additionally, or alternatively, if deciphering using the first HFN 215, the second HFN 215, and the third HFN 215 fails, the UE 115-a may be unable to resolve the HFN desynchronization.

In some other cases, to resolve HFN desynchronization, the UE 115-a may release a connection (e.g., RRC connection) with the network entity 105-a to reset the counter 225-a and the counter 225-b. However, releasing the connection may result in high interruption time (e.g., interruption time exceeding a threshold interruption time), disruption to multiple bearers (e.g., all bearers) supported by the UE 115-a when the HFN desynchronization may be associated with a single bearer (e.g., of the multiple bearers), and overhead associated with connection re-establishment (e.g., RRC re-establishment).

Accordingly, techniques described herein may enable the UE 115-a to indicate HFN desynchronization to the network entity 105-a, such that the network entity 105-a may correct the HFN desynchronization (e.g., rather than the UE 115-a attempting to correct the HFN desynchronization). For example, the network entity 105-a may transmit, to the UE 115-a (e.g., via a control message), configuration information 230 (e.g., a reporting configuration) indicating information associated with reporting of HFN desynchronization. That is, the configuration information 230 may indicate one or more trigger events (e.g., user plane events, reporting events) for which the UE 115-a is to report HF desynchronization, a format of a report 235 associated with HFN desynchronization, or both.

For example, the configuration information 230 may indicate one or more thresholds associated with HFN desynchronization, where the one or more trigger events may be based on satisfaction of the one or more thresholds. In some cases, the one or more thresholds may include a threshold quantity of consecutive instances of HFN desynchronization, which may be referred to as HFN desynchronization instances. That is, satisfaction of a first trigger event (e.g., of the one or more trigger events) may be based on a quantity of consecutive HFN desynchronization instances detected by the UE 115-a satisfying (e.g., meeting or exceeding) the threshold quantity of consecutive instances of HFN desynchronization.

An HFN desynchronization instance may be an instance of the UE 115-a detecting that HFN desynchronization has occurred for a P PDU 205. That is, each PDCP PDU 205 received by the UE 115-a may be associated with either an instance of HFN synchronization (e.g., when an HFN 215 determined by the UE 115-a and an HFN determined by the network entity 105-a is the same, or synchronized, for the same PDCP PDU 205) or an instance of HFN desynchronization (e.g., when the HFN 215 determined by the UE 115-a is not the same as, or is desynchronized with, the HFN 215 determined by the network entity 105-a for the same PDCP PDU 205). For example, an HFN desynchronization instance may be an instance of the UE 115-a receiving a PDCP PDU 205 and failing to decipher the PDCP PDU 205 or an instance of the UE 115-a receiving a PDCP PDU 205 and the PDCP PDU 205 failing an integrity check.

Additionally, or alternatively, the one or more thresholds may include a threshold quantity of HFN desynchronization instances (e.g., consecutive or not) relative to a quantity of received PDCP PDUs 205 (e.g., a quantity of deciphering attempts). That is, satisfaction of a second trigger event (e.g., of the one or more trigger events) may be based on a quantity of HFN desynchronization instances detected by the UE 115-a within the quantity of received PDCP PDUs 205 satisfying (e.g., meeting or exceeding) the threshold quantity of HFN desynchronization instances (e.g., relative to the quantity of received PDCP PDUs 205). For example, the threshold quantity of HFN desynchronization instances may be K HFN desynchronization instances relative to N received PDCP PDUs 205 (e.g., K-out-of-N), such that satisfaction of the second trigger event may be based on the UE 115-a detecting at least K HFN desynchronization instances within N PDCP PDUs 205 (e.g., within N attempts of deciphering PDCP PDUs 205).

In some cases, the configuration information 230 may additionally indicate a duration of a timer (e.g., a duration of a prohibit timer), such that the UE 115-a may wait the duration after detecting HFN desynchronization (e.g., after detecting satisfaction of at least a subset of the one or more trigger events) before transmitting the report 235 indicating HFN desynchronization (e.g., to ensure that HFN desynchronization lasts long enough to result in transmission of the report 235 and subsequent action by the network entity 105-a). That is, the UE 115-a may detect satisfaction of at least the subset of the one or more trigger events at a first time and may transmit the report 235 indicative of HFN desynchronization at a second time (e.g., after, or based on, expiration of the timer), where a difference between the first time and the second time is equal to (e.g., or greater than) the duration indicative via the configuration information 230. In some cases, if HFN desynchronization is resolved prior to expiration of the timer, the UE 115-a may refrain from transmitting the report 235. Conversely, if HFN desynchronization is not resolved prior to expiration of the timer, the UE 115-a may transmit the report 235.

As such, as described herein, the UE 115-a (e.g., a user plane of the UE 115-a) may monitor for HFN desynchronization (e.g., monitor for the one or more trigger events) and may report HFN desynchronization based on satisfaction of at least a subset of the one or more trigger events (e.g., and based on expiration of the timer). That is, the UE 115-a may transmit, to the network entity 105-a, the report 235 indicative of HFN desynchronization based on satisfaction of at least a subset of the one or more trigger events (e.g., conditions). In some cases, the report 235 may indicate (e.g., via HFN desynchronization information) the quantity of consecutive HFN desynchronization instances detected by the UE 115-a (e.g., based on satisfaction of the first trigger event), the quantity of HFN desynchronization instances (e.g., consecutive or not) detected by the UE 115-a relative to the quantity of received PDCP PDUs 205 (e.g., based on satisfaction of the second trigger event), or both. Additionally, or alternatively, the report 235 may indicate (e.g., via the HFN desynchronization information) a bearer ID associated with the HFN desynchronization, a respective value of the counter 225-b (e.g., determined by the UE 115-a) associated with each HFN desynchronization instance detected by the UE 115-a (e.g., of out-of-sync service data units (SDUs)), a respective HFN 215 associated with each HFN desynchronization instance detected by the UE 115-a, a respective SN 210 associated with each HFN desynchronization instance detected by the UE 115-a, a value of the counter 225-b associated with a last correctly received PDCP PDU 205 (e.g., a last correctly deciphered PDCP PDU 205 prior to HFN desynchronization), a value of the counter 225-b associated with a first HFN desynchronization instance detected by the UE 115-a (e.g., a first missing, or incorrect, COUNT), or any combination thereof.

In some cases, the UE 115-a may transmit the report 235 via RRC signaling (e.g., on signaling radio bearer (SRB)1, SRB2, or SRB3, similar to measurement reports for mobility). In some other cases, the UE 115-a may transmit the report 235 via UE assistance information (UAI), a medium access control (MAC)-control element (MAC-CE) message, a PDCP control PDU 205, or any combination thereof.

As such, the network entity 105-a, the UE 115-a, or both, may resolve HFN desynchronization based on reception of the report 235. For example, in some cases, the network entity 105-a may correct, or resolve, the HFN desynchronization via PDCP re-establishment, via releasing and re-adding of a single bearer associated with the HFN desynchronization (e.g., to reset the counters 225 without RRC release), or via another method for resolving HFN desynchronization.

In some cases, the UE 115-a may support dual-connectivity. That is, the network entity 105-a may be associated with multiple radio link control (RLC) control entities, such as a first RLC entity and a second RLC entity, such that the UE 115-a may support a first communication link (e.g., connection) with the first RLC entity and a second communication link with the second RLC entity. In such cases, SNs 210 associated with PDCP PDUs 205 transmitted by each RLC entity, which may be referred to as RLC SNs 210, may differ. That is, the UE 115-a may receive a first PDCP PDU 205 from the first RLC entity, where the first PDCP PDU 205 indicates a first SN 210, and may receive (e.g., simultaneously) a second PDCP PDU 205 (e.g., carrying the same or different data 220 as the first PDCP PDU 205) from the second RLC entity, where the second PDCP PDU 205 indicates a second SN 210. In such cases, the first SN 210 may be different than the second SN 210. Thus, a first HFN 215 associated with the first PDCP PDU 205 may also differ from a second HFN 215 associated with the second PDCP PDU 205 (e.g., due to HFN 215 being based on SN 210). As such, the UE 115-a may maintain a separate value of the counter 225-b (e.g., a separate COUNT) for each RLC entity (e.g., associated with each communication link).

Thus, in some cases, HFN desynchronization may occur with one RLC entity but not the other (e.g., may occur on a single communication link rather than both communication links), such that the network entity 105-a may not need to release a bearer associated with both RLC entities (e.g., the first RLC entity and the second RLC entity) and may be capable of instead releasing a communication link associated with the HFN desynchronization. As such, to enable the releasing of a single communication link (e.g., rather than the bearer associated with both RLC entities), the UE 115-a may monitor and report HFN desynchronization separately for each RLC entity.

For example, in some cases, the UE 115-a may monitor for HFN desynchronization (e.g., monitor for satisfaction of at least a subset of the one or more trigger conditions) separately per communication link (e.g., per RLC entity) but may transmit a single report 235 for both RLC entities, where the single report 235 indicates separate HFN desynchronization information associated with each RLC entity. For example, the single report 235 may indicate a first ID associated with the first RLC entity, first HFN desynchronization information associated with the first ID, a second ID associated with the second RLC entity, second HFN desynchronization information associated with the second ID, or any combination thereof. In some cases, the UE 115-a may include, in the single report 235, HFN desynchronization information associated with RLC entities for which HFN desynchronization has occurred and may exclude HFN desynchronization information associated with RLC entities for which HFN desynchronization has not occurred. For example, if the UE 115-a detects HFN desynchronization associated with the first RLC entity but not the second RLC entity, the single report 235 may indicate the first ID associated with the first RLC entity and the first HFN desynchronization information associated with the first ID (e.g., and exclude the second ID associated with the second RLC entity and the second HFN desynchronization information associated with the second ID).

In some other cases, the UE 115-a may monitor for HFN desynchronization (e.g., monitor for satisfaction of at least a subset of the one or more trigger conditions) separately per communication link (e.g., per RLC entity) and may transmit separate reports 235 for each RLC entity. For example, if the UE 115-a detects HFN desynchronization associated with the first RLC entity but not the second RLC entity, the UE 115-a may transmit, via the first communication link, a first report 235 indicating HFN desynchronization associated with the first RLC entity (e.g., indicating the first ID associated with the first RLC entity and the first HFN desynchronization information associated with the first ID). Additionally, the UE 115-a may refrain from transmitting, via the second communication link, a second report 235 due to the second RLC entity being associated with synchronized HFNs 215 (e.g., and may also refrain from transmitting the first report 235 via the second communication link). Conversely, if the UE 115-a detects HFN desynchronization associated with the first RLC entity and HFN desynchronization associated with the second RLC entity, the UE 115-a may transmit, via the first communication link, the first report 235 indicating HFN desynchronization associated with the first RLC entity and may transmit, via the second communication link, the second report 235 indicating HFN desynchronization associated with the second RLC entity.

In some examples, in addition to, or alternatively to, the HFN desynchronization information to be reported (e.g., as configured via the configuration information 230), as described herein, the UE 115-a may indicate a respective RLC SN 210 associated with each HFN desynchronization instance. As such, if the network entity 105-a also supports separate values of the counter 225-a per RLC entity (e.g., RLC SN-PDCP COUNT mapping), the network entity 105-a may be able to (e.g., may be capable of) estimating missing SDUs due to HFN desynchronization. Thus, if a bearer is release and re-established (e.g., based on reception of a report 235 by the network entity 105-a), the network entity 105-a may be able to identify a value of the counter 225-b (e.g., at the UE 115-a) for a first missed PDCP PDU 205 and may transmit, to the UE 115-a, an indication of the value of the counter 225-b for the first missed PDCP PDU 205.

In some cases, the UE 115-a may declare radio link failure (RLF) based on HFN desynchronization. In other words, HFN desynchronization may be considered a trigger condition for declaration of RLF. As such, when the UE 115-a detects HFN desynchronization (e.g., based on satisfaction of at least a subset of the one or more trigger events associated with HFN desynchronization), the UE 115-a may declare RLF. In some cases, the UE 115-a may declare RLF by transmitting a report 235 indicating HFN desynchronization. In some other cases, the UE 115-a may transmit a control message indicating RLF, where the control message further indicates that a cause of the RLF is HFN desynchronization.

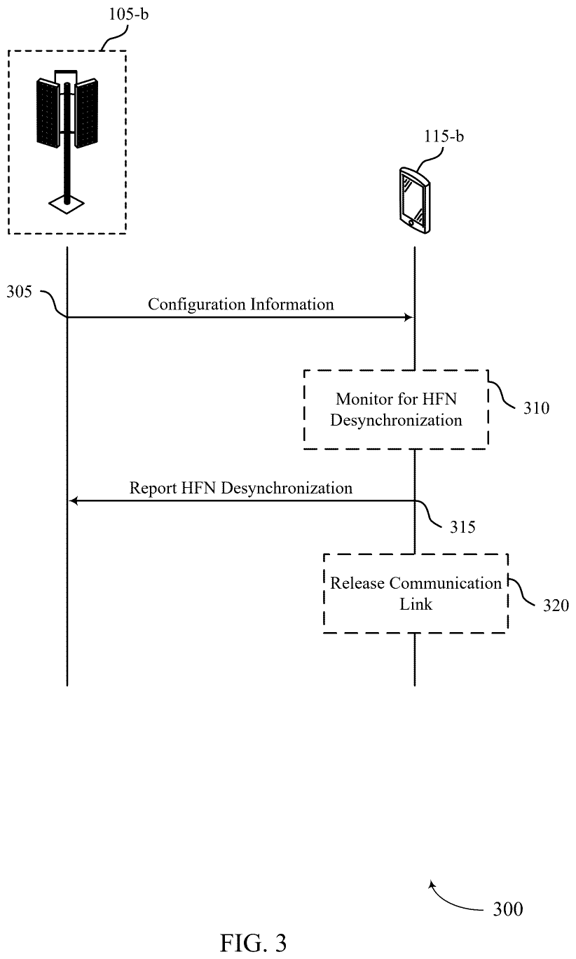

FIG. 3 shows an example of a process flow 300 that supports techniques for UE reporting of HFN desynchronization in accordance with one or more aspects of the present disclosure. In some cases, the process flow 300 may implement or be implemented by aspects of the wireless communications system 100, the wireless communications system 200, or both. For example, the process flow 300 may include one or more UEs 115 (e.g., a UE 115-b) and one or more network entities 105 (e.g., a network entity 105-b), which may be examples of the corresponding devices as described herein. In the following description of the process flow 300, the operations between the UE 115-b and the network entity 105-b may be communicated in a different order than the example order shown, or the operations performed by the UE 115-b and the network entity 105-b may be performed in different orders or at different times. Some operations may also be omitted from the process flow 300, and other operations may be added to the process flow 300.

At 305, the UE 115-b may receive, from the network entity 105-b, configuration information (e.g., a reporting configuration) indicative of one or more trigger events for which the UE 115-a is to report HFN desynchronization between the UE 115-b and a network entity 105-b. In such cases, the configuration information may indicate information associated with the one or more trigger evets, HFN desynchronization information to be reported by the UE 115-b, or both. For example, the configuration information may indicate a threshold quantity of instances of HFN desynchronization (e.g., HFN desynchronization instances). In some cases, the threshold quantity of instances of HFN desynchronization may include a first threshold quantity of consecutive instances of HFN desynchronization, a second threshold quantity of instances of HFN desynchronization (e.g., consecutive or not) relative to a total quantity of PDUs (e.g., a total quantity of deciphering attempts), or both. Additionally, or alternatively, the configuration information may indicate a duration of a timer (e.g., prohibit timer) associated with reporting HFN desynchronization.

In some cases, at 310, the UE 115-b may monitor for HFN desynchronization. That is, the UE 115-b receive a set of PDCP PDUs and may monitor for (e.g., and detect) instances of HFN desynchronization (e.g., based on failed deciphering, failed integrity checks, or both). That is, each PDCP PDU may be associated with either an instance of HFN synchronization (e.g., when an HFN determined by the UE 115-b and an HFN determined by the network entity 105-b is the same, or synchronized, for the same PDCP PDU) or an instance of HFN desynchronization (e.g., when the HFN determined by the UE 115-b is not the same as, or is desynchronized with, the HFN determined by the network entity 105-b for the same PDCP PDU). Additionally, the UE 115-b may monitor for satisfaction of at least a subset of the one or more trigger conditions based on a quantity of instances of HFN desynchronization detected by the UE 115-b.

At 315, the UE 115-b may transmit, to the network entity 105-b in accordance with the configuration information, a report indicative of HFN desynchronization based on satisfaction of at least a subset of the one or more trigger events. For example, the UE 115-b may transmit the report indicative of HFN desynchronization based on the quantity of instances of HFN desynchronization detected by the UE 115-b satisfying (e.g., meeting or exceeding) the threshold quantity of instances of HFN desynchronization (e.g., as indicated via the configuration information). Additionally. or alternatively, the UE 115-b may transmit the report based on expiration of the timer, where the timer is started based on satisfaction of the at least subset of the one or more trigger events. In some examples, the UE 115-b may declare RLF based on HFN synchronization, where declaring RLF includes transmitting the report.

In some cases, the report may include an indication of the quantity of instances of HFN desynchronization detected by the UE 115-b, a bearer ID associated with the HFN desynchronization, a respective SN associated with each instance of HFN desynchronization from the quantity of instances of HFN desynchronization detected by the UE 115-b, a respective counter value associated with each instance of HFN desynchronization from the quantity of instances of HFN desynchronization detected by the UE 115-b, a counter value associated with a last successful instance of HFN synchronization (e.g., a last successful deciphered PDCP PDU) prior to reporting of the HFN desynchronization, or any combination thereof. Additionally, or alternatively, the UE 115-b may transmit the report via an RRC message, a MAC-CE message, a PDCP control message, or any combination thereof.

In some cases, the network entity 105-b may be associated with a first RLC entity and a second RLC entity, the UE 115-b may support a first communication link associated with the first RLC entity and a second communication link associated with the RLC entity in accordance with a dual connectivity configuration. In such cases, the UE 115-b may transmit the report via the first communication link based on the HFN desynchronization being associated with the first RLC entity. In such cases, the report may include an ID associated with the first RLC entity, a respective SN (e.g., RLC SN) associated with each instance of HFN desynchronization, or both.

In some cases, at 320, the UE 115-b may release the first communication link based on transmission of the report.

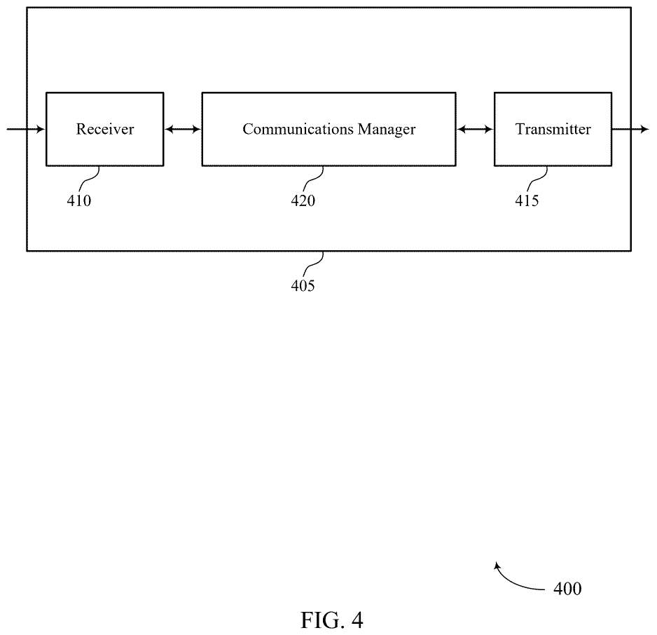

FIG. 4 shows a block diagram 400 of a device 405 that supports techniques for UE reporting of HFN desynchronization in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to techniques for UE reporting of HFN desynchronization). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to techniques for UE reporting of HFN desynchronization). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of techniques for UE reporting of HFN desynchronization as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving configuration information indicative of one or more trigger events for which the UE is to report HFN desynchronization between the UE and a network entity. The communications manager 420 is capable of, configured to, or operable to support a means for transmitting, in accordance with the configuration information, a report indicative of HFN desynchronization based on satisfaction of the one or more trigger events.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for UE reporting of HFN desynchronization, which may result in reduced processing, reduced power consumption, and more efficient utilization of communication resources, among other advantages.

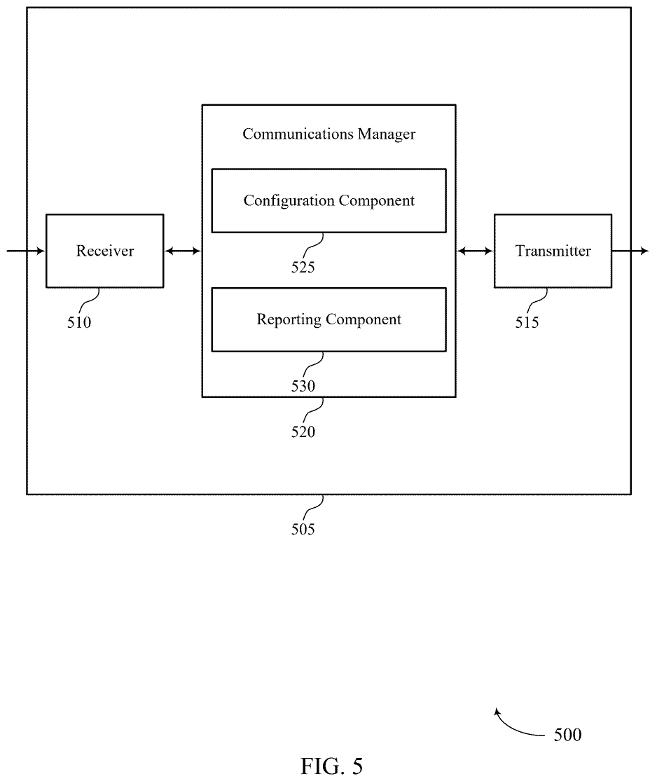

FIG. 5 shows a block diagram 500 of a device 505 that supports techniques for UE reporting of HFN desynchronization in accordance with one or more aspects of the present disclosure. The device 505 may be an example of aspects of a device 405 or a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for UE reporting of HFN desynchronization). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for UE reporting of HFN desynchronization). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of techniques for UE reporting of HFN desynchronization as described herein. For example, the communications manager 520 may include a configuration component 525 a reporting component 530, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The configuration component 525 is capable of, configured to, or operable to support a means for receiving configuration information indicative of one or more trigger events for which the UE is to report HFN desynchronization between the UE and a network entity. The reporting component 530 is capable of, configured to, or operable to support a means for transmitting, in accordance with the configuration information, a report indicative of HFN desynchronization based on satisfaction of the one or more trigger events.

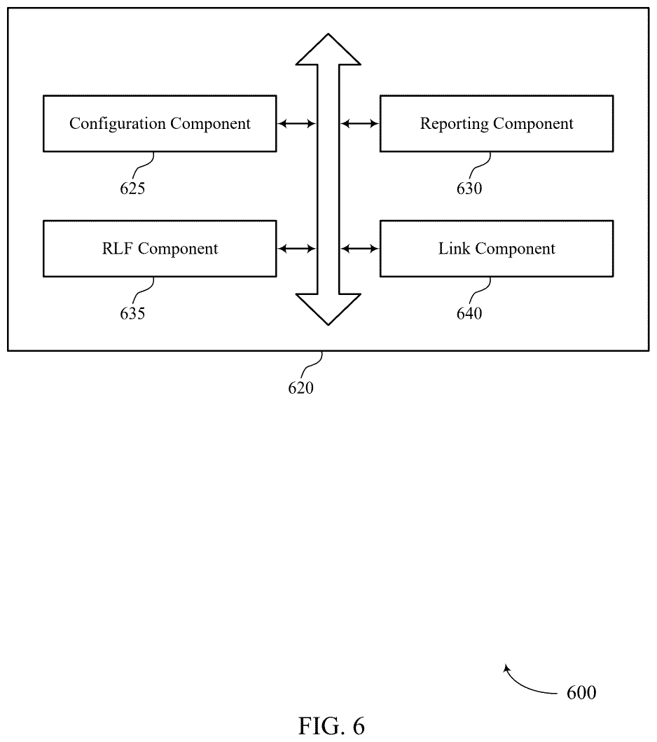

FIG. 6 shows a block diagram 600 of a communications manager 620 that supports techniques for UE reporting of HFN desynchronization in accordance with one or more aspects of the present disclosure. The communications manager 620 may be an example of aspects of a communications manager 420, a communications manager 520, or both, as described herein. The communications manager 620, or various components thereof, may be an example of means for performing various aspects of techniques for UE reporting of HFN desynchronization as described herein. For example, the communications manager 620 may include a configuration component 625, a reporting component 630, an RLF component 635, a link component 640, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The configuration component 625 is capable of, configured to, or operable to support a means for receiving configuration information indicative of one or more trigger events for which the UE is to report HFN desynchronization between the UE and a network entity. The reporting component 630 is capable of, configured to, or operable to support a means for transmitting, in accordance with the configuration information, a report indicative of HFN desynchronization based on satisfaction of the one or more trigger events.

In some examples, the configuration information is indicative of a threshold quantity of instances of HFN desynchronization. In some examples, satisfaction of the one or more trigger events is based on a quantity of instances of HFN desynchronization detected by the UE satisfying the threshold quantity of instances of HFN desynchronization.

In some examples, the threshold quantity of instances of HFN desynchronization includes a threshold quantity of consecutive instances of HFN desynchronization or a threshold quantity of instances of HFN desynchronization relative to a total quantity of packet data units.

In some examples, to support transmitting the report, the reporting component 630 is capable of, configured to, or operable to support a means for transmitting the report based on expiration of a timer, where the timer is started based on satisfaction of the one or more trigger events.

In some examples, the configuration information includes an indication of a duration of the timer.

In some examples, the report includes an indication of a quantity of instances of HFN desynchronization, a bearer identifier associated with the HFN desynchronization, a respective sequence number associated with each instance of HFN desynchronization from the quantity of instances of HFN desynchronization, a respective counter value associated with each instance of HFN desynchronization from the quantity of instances of HFN desynchronization, a counter value associated with a last successful instance of HFN synchronization prior to reporting of the HFN desynchronization, or any combination thereof.

In some examples, to support transmitting the report, the reporting component 630 is capable of, configured to, or operable to support a means for transmitting the report via the first communication link based on the HFN desynchronization being associated with the first RLC entity.

In some examples, the report includes an indication of an identifier associated with the first RLC entity, a respective sequence number associated with each instance of HFN desynchronization, or both.

In some examples, the link component 640 is capable of, configured to, or operable to support a means for releasing the first communication link based on transmission of the report.

In some examples, the RLF component 635 is capable of, configured to, or operable to support a means for declaring RLF based on the HFN desynchronization, where declaring RLF includes transmission of the report.

In some examples, the report is transmitted via an RRC message, via a MAC-CE message, via a PDCP control message, or any combination thereof.

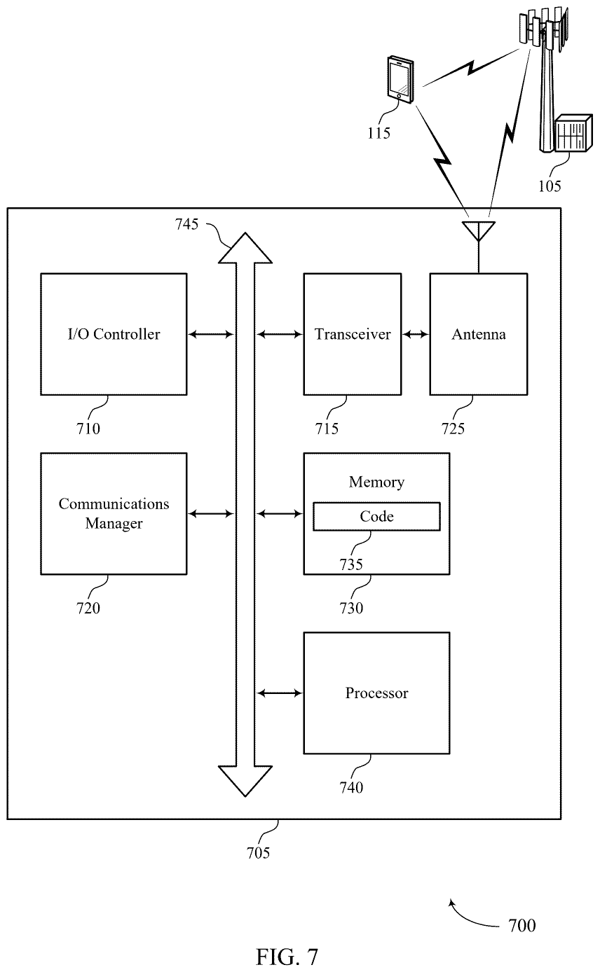

FIG. 7 shows a diagram of a system 700 including a device 705 that supports techniques for UE reporting of HFN desynchronization in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting techniques for UE reporting of HFN desynchronization). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

The communications manager 720 may support wireless communications in accordance with examples as disclosed herein. For example, the communications manager 720 is capable of, configured to, or operable to support a means for receiving configuration information indicative of one or more trigger events for which the UE is to report HFN desynchronization between the UE and a network entity. The communications manager 720 is capable of, configured to, or operable to support a means for transmitting, in accordance with the configuration information, a report indicative of HFN desynchronization based on satisfaction of the one or more trigger events.

By including or configuring the communications manager 720 in accordance with examples as described herein, the device 705 may support techniques for UE reporting of HFN desynchronization, which may result in improved communication reliability, reduced latency, improved user experience related to reduced processing, reduced power consumption, more efficient utilization of communication resources, improved coordination between devices, longer battery life, improved utilization of processing capability, among other advantages.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of techniques for UE reporting of HFN desynchronization as described herein, or the at least one processor 740 and the at least one memory 730 may be otherwise configured to, individually or collectively, perform or support such operations.

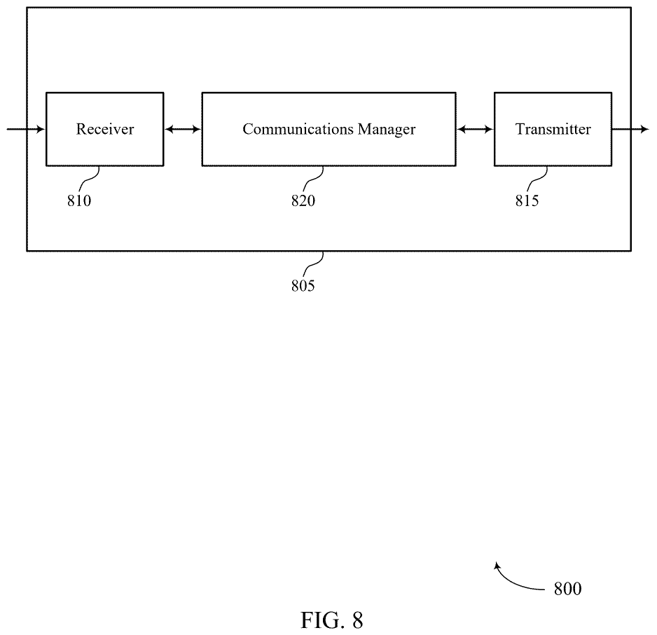

FIG. 8 shows a block diagram 800 of a device 805 that supports techniques for UE reporting of HFN desynchronization in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of techniques for UE reporting of HFN desynchronization as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting configuration information indicative of one or more trigger events for which a UE is to report HFN desynchronization between the UE and the network entity. The communications manager 820 is capable of, configured to, or operable to support a means for receiving, in accordance with the configuration information, a report indicative of HFN desynchronization.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for UE reporting of HFN desynchronization, which may result in reduced processing, reduced power consumption, and more efficient utilization of communication resources, among other advantages.

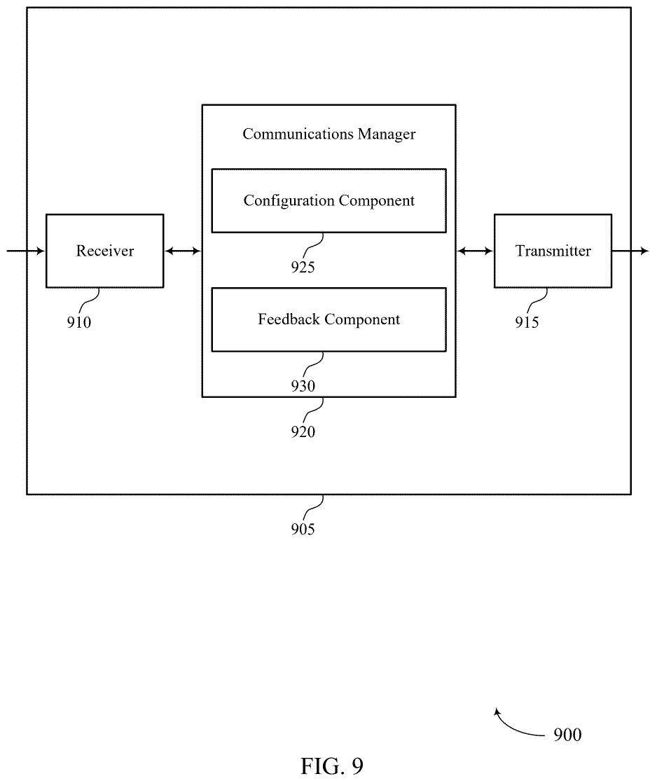

FIG. 9 shows a block diagram 900 of a device 905 that supports techniques for UE reporting of HFN desynchronization in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of techniques for UE reporting of HFN desynchronization as described herein. For example, the communications manager 920 may include a configuration component 925 a feedback component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The configuration component 925 is capable of, configured to, or operable to support a means for transmitting configuration information indicative of one or more trigger events for which a UE is to report HFN desynchronization between the UE and the network entity. The feedback component 930 is capable of, configured to, or operable to support a means for receiving, in accordance with the configuration information, a report indicative of HFN desynchronization.

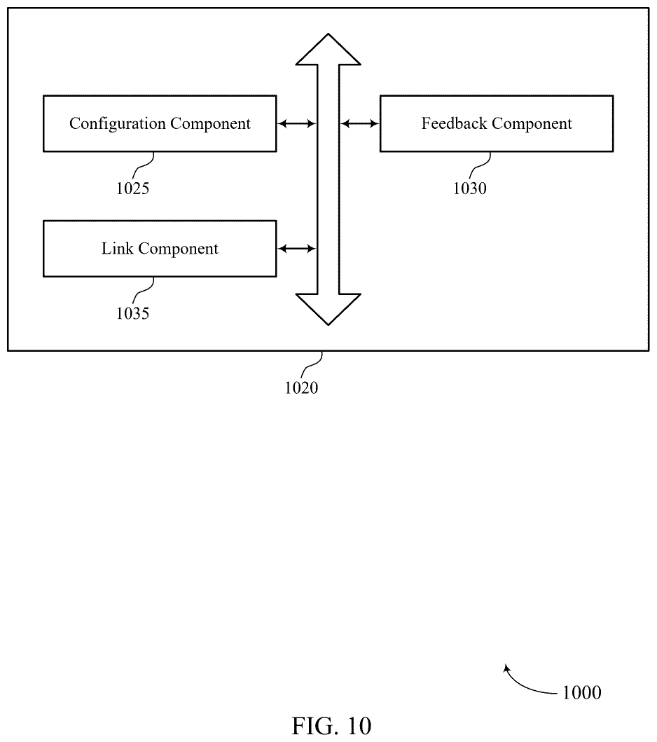

FIG. 10 shows a block diagram 1000 of a communications manager 1020 that supports techniques for UE reporting of HFN desynchronization in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for UE reporting of HFN desynchronization as described herein. For example, the communications manager 1020 may include a configuration component 1025, a feedback component 1030, a link component 1035, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The configuration component 1025 is capable of, configured to, or operable to support a means for transmitting configuration information indicative of one or more trigger events for which a UE is to report HFN desynchronization between the UE and the network entity. The feedback component 1030 is capable of, configured to, or operable to support a means for receiving, in accordance with the configuration information, a report indicative of HFN desynchronization.

In some examples, the configuration information is indicative of a threshold quantity of instances of HFN desynchronization. In some examples, the one or more trigger events incolude a quantity of instances of HFN desynchronization detected by the UE satisfying the threshold quantity of instances of HFN desynchronization.

In some examples, the threshold quantity of instances of HFN desynchronization includes a threshold quantity of consecutive instances of HFN desynchronization or a threshold quantity of instances of HFN desynchronization relative to a total quantity of packet data units.

In some examples, the configuration information includes an indication of a duration of a timer.

In some examples, the report includes an indication of a quantity of instances of HFN desynchronization, a bearer identifier associated with the HFN desynchronization, a respective sequence number associated with each instance of HFN desynchronization from the quantity of instances of HFN desynchronization, a respective counter value associated with each instance of HFN desynchronization from the quantity of instances of HFN desynchronization, a counter value associated with a last successful instance of HFN synchronization prior to reporting of the HFN desynchronization, or any combination thereof.

In some examples, the network entity is associated with a first RLC entity and a second RLC entity, where the first RLC entity is associated with a first communication link, and where the second RLC entity is associated with a second communication link. In such cases, the report may be received via the first communication link based on the HFN desynchronization being associated with the first RLC entity.

In some examples, the report includes an indication of an identifier associated with the first RLC entity, a respective sequence number associated with each instance of HFN desynchronization, or both.

In some examples, the link component 1035 is capable of, configured to, or operable to support a means for releasing the first communication link based on reception of the report.

In some examples, the report includes an indication of radio link failure.

In some examples, the report is received via an RRC message, via a MAC-CE message, via a PDCP control message, or any combination thereof.

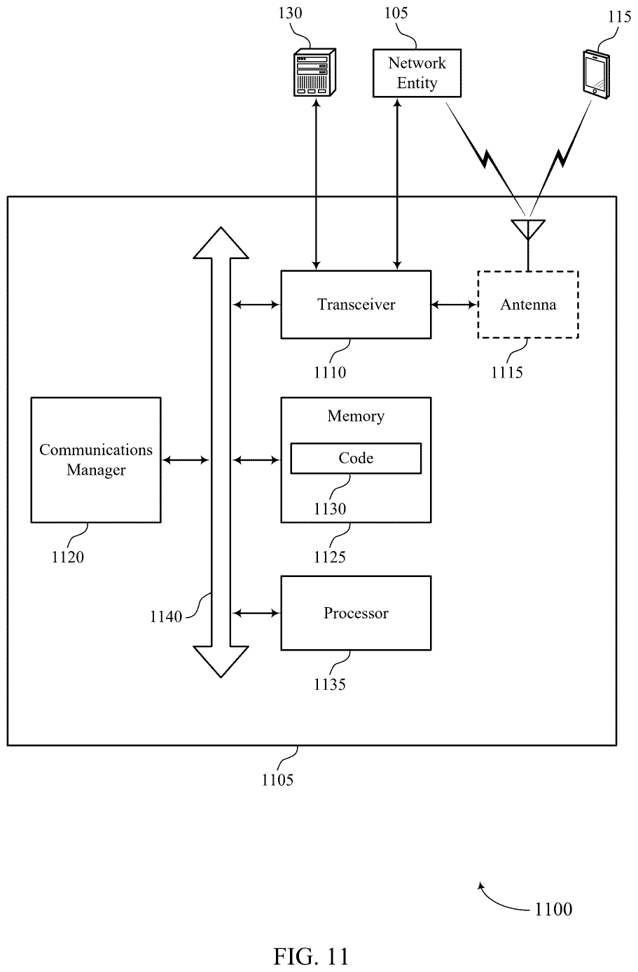

FIG. 11 shows a diagram of a system 1100 including a device 1105 that supports techniques for UE reporting of HFN desynchronization in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting techniques for UE reporting of HFN desynchronization). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting configuration information indicative of one or more trigger events for which a UE is to report HFN desynchronization between the UE and the network entity. The communications manager 1120 is capable of, configured to, or operable to support a means for receiving, in accordance with the configuration information, a report indicative of HFN desynchronization.

By including or configuring the communications manager 1120 in accordance with examples as described herein, the device 1105 may support techniques for UE reporting of HFN desynchronization, which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of techniques for UE reporting of HFN desynchronization as described herein, or the at least one processor 1135 and the at least one memory 1125 may be otherwise configured to, individually or collectively, perform or support such operations.

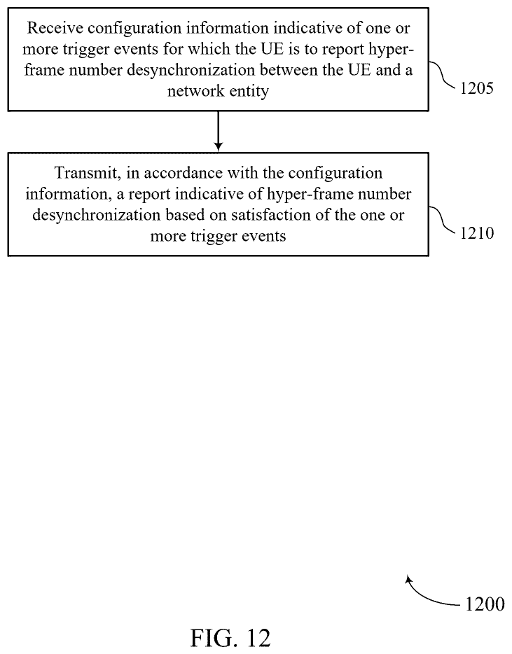

FIG. 12 shows a flowchart illustrating a method 1200 that supports techniques for UE reporting of HFN desynchronization in accordance with one or more aspects of the present disclosure. The operations of the method 1200 may be implemented by a UE or its components as described herein. For example, the operations of the method 1200 may be performed by a UE 115 as described with reference to FIGS. 1 through 7. In some examples, a UE may execute a set of instructions to control the functional elements of the UE to perform the described functions. Additionally, or alternatively, the UE may perform aspects of the described functions using special-purpose hardware.

At 1205, the method may include receiving configuration information indicative of one or more trigger events for which the UE is to report HFN desynchronization between the UE and a network entity. The operations of 1205 may be performed in accordance with examples as disclosed herein. In some examples, aspects of the operations of 1205 may be performed by a configuration component 625 as described with reference to FIG. 6.

At 1210, the method may include transmitting, in accordance with the configuration information, a report indicative of HFN desynchronization based on satisfaction of the one or more trigger events. The operations of 1210 may be performed in accordance with examples as disclosed herein. In some examples, aspects of the operations of 1210 may be performed by a reporting component 630 as described with reference to FIG. 6.

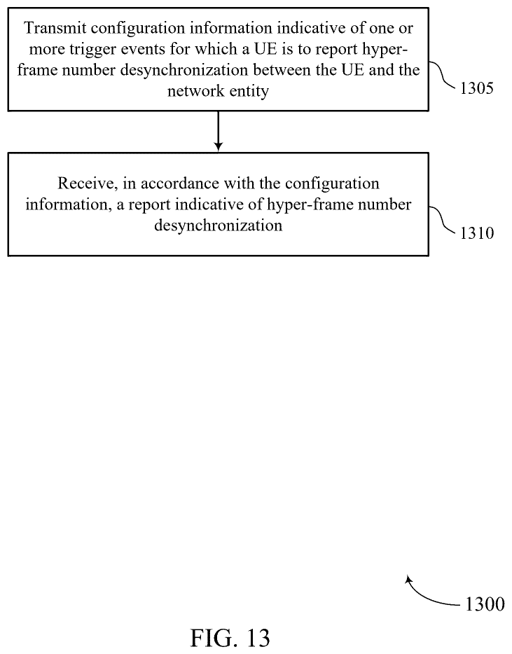

FIG. 13 shows a flowchart illustrating a method 1300 that supports techniques for UE reporting of HFN desynchronization in accordance with one or more aspects of the present disclosure. The operations of the method 1300 may be implemented by a network entity or its components as described herein. For example, the operations of the method 1300 may be performed by a network entity as described with reference to FIGS. 1 through 3 and 8 through 11. In some examples, a network entity may execute a set of instructions to control the functional elements of the network entity to perform the described functions. Additionally, or alternatively, the network entity may perform aspects of the described functions using special-purpose hardware.

At 1305, the method may include transmitting configuration information indicative of one or more trigger events for which a UE is to report HFN desynchronization between the UE and the network entity. The operations of 1305 may be performed in accordance with examples as disclosed herein. In some examples, aspects of the operations of 1305 may be performed by a configuration component 1025 as described with reference to FIG. 10.

At 1310, the method may include receiving, in accordance with the configuration information, a report indicative of HFN desynchronization. The operations of 1310 may be performed in accordance with examples as disclosed herein. In some examples, aspects of the operations of 1310 may be performed by a feedback component 1030 as described with reference to FIG. 10.

The following provides an overview of aspects of the present disclosure:

Aspect 1: A method for wireless communications at a UE, comprising: receiving configuration information indicative of one or more trigger events for which the UE is to report HFN desynchronization between the UE and a network entity; and transmitting, in accordance with the configuration information, a report indicative of HFN desynchronization based at least in part on satisfaction of the one or more trigger events.

Aspect 2: The method of aspect 1, wherein the configuration information is indicative of a threshold quantity of instances of HFN desynchronization, and satisfaction of the one or more trigger events is based at least in part on a quantity of instances of HFN desynchronization detected by the UE satisfying the threshold quantity of instances of HFN desynchronization.

Aspect 3: The method of aspect 2, wherein the threshold quantity of instances of HFN desynchronization comprises a threshold quantity of consecutive instances of HFN desynchronization or a threshold quantity of instances of HFN desynchronization relative to a total quantity of PDUs.

Aspect 4: The method of any of aspects 1 through 3, wherein transmitting the report comprises: transmitting the report based at least in part on expiration of a timer, wherein the timer is started based at least in part on satisfaction of the one or more trigger events.

Aspect 5: The method of aspect 4, wherein the configuration information comprises an indication of a duration of the timer.

Aspect 6: The method of any of aspects 1 through 5, wherein the report comprises an indication of a quantity of instances of HFN desynchronization, a bearer identifier associated with the HFN desynchronization, a respective SN associated with each instance of HFN desynchronization from the quantity of instances of HFN desynchronization, a respective counter value associated with each instance of HFN desynchronization from the quantity of instances of HFN desynchronization, a counter value associated with a last successful instance of HFN synchronization prior to reporting of the HFN desynchronization, or any combination thereof.

Aspect 7: The method of any of aspects 1 through 6, wherein the network entity is associated with a first RLC entity and a second RLC entity, wherein the UE supports a first communication link associated with the first RLC entity and a second communication link associated with the second RLC entity in accordance with a dual connectivity configuration, and wherein transmitting the report comprises: transmitting the report via the first communication link based at least in part on the HFN desynchronization being associated with the first RLC entity.

Aspect 8: The method of aspect 7, wherein the report comprises an indication of an identifier associated with the first RLC entity, a respective SN associated with each instance of HFN desynchronization, or both.

Aspect 9: The method of any of aspects 7 through 8, further comprising: releasing the first communication link based at least in part on transmission of the report.

Aspect 10: The method of any of aspects 1 through 9, further comprising: declaring RLF based at least in part on the HFN desynchronization, wherein declaring RLF comprises transmission of the report.

Aspect 11: The method of any of aspects 1 through 10, wherein the report is transmitted via an RRC message, via a MAC-CE message, via a PDCP message,, or any combination thereof.

Aspect 12: A method for wireless communications at a network entity, comprising: transmitting configuration information indicative of one or more trigger events for which a UE is to report HFN desynchronization between the UE and the network entity; and receiving, in accordance with the configuration information, a report indicative of HFN desynchronization.

Aspect 13: The method of aspect 12, wherein the configuration information is indicative of a threshold quantity of instances of HFN desynchronization, and the one or more trigger events includes a quantity of instances of HFN desynchronization detected by the UE satisfying the threshold quantity of instances of HFN desynchronization.

Aspect 14: The method of aspect 13, wherein the threshold quantity of instances of HFN desynchronization comprises a threshold quantity of consecutive instances of HFN desynchronization or a threshold quantity of instances of HFN desynchronization relative to a total quantity of PDUs.

Aspect 15: The method of aspect 12, wherein the configuration information comprises an indication of a duration of a timer.

Aspect 16: The method of any of aspects 12 through 15, wherein the report comprises an indication of a quantity of instances of HFN desynchronization, a bearer identifier associated with the HFN desynchronization, a respective SN associated with each instance of HFN desynchronization from the quantity of instances of HFN desynchronization, a respective counter value associated with each instance of HFN desynchronization from the quantity of instances of HFN desynchronization, a counter value associated with a last successful instance of HFN synchronization prior to reporting of the HFN desynchronization, or any combination thereof.

Aspect 17: The method of any of aspects 12 through 16, wherein the network entity is associated with a first RLC entity and a second RLC entity, wherein the first RLC entity is associated with a first communication link, wherein the second RLC entity is associated with a second communication link, and wherein the report is received via the first communication link based at least in part on the HFN desynchronization being associated with the first RLC entity.

Aspect 18: The method of aspect 17, wherein the report comprises an indication of an identifier associated with the first RLC entity, a respective SN associated with each instance of HFN desynchronization, or both.

Aspect 19: The method of any of aspects 17 through 18, further comprising: releasing the first communication link based at least in part on reception of the report.

Aspect 20: The method of any of aspects 12 through 19, wherein the report comprises an indication of RLF.

Aspect 21: The method of any of aspects 12 through 20, wherein the report is received via an RRC message, via a MAC-CE message, via a PDCP message,, or any combination thereof.

Aspect 22: A UE for wireless communications, comprising one or more memories storing processor-executable code, and one or more processors coupled with the one or more memories and individually or collectively operable to execute the code to cause the UE to perform a method of any of aspects 1 through 11.

Aspect 23: A UE for wireless communications, comprising at least one means for performing a method of any of aspects 1 through 11.

Aspect 24: A non-transitory computer-readable medium storing code for wireless communications, the code comprising instructions executable by one or more processors to perform a method of any of aspects 1 through 11.

Aspect 25: A network entity for wireless communications, comprising one or more memories storing processor-executable code, and one or more processors coupled with the one or more memories and individually or collectively operable to execute the code to cause the network entity to perform a method of any of aspects 12 through 21.

Aspect 26: A network entity for wireless communications, comprising at least one means for performing a method of any of aspects 12 through 21.

Aspect 27: A non-transitory computer-readable medium storing code for wireless communications, the code comprising instructions executable by one or more processors to perform a method of any of aspects 12 through 21.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive configuration information indicative of one or more trigger events for which the UE is to report hyper-frame number desynchronization between the UE and a network entity; and
transmit, in accordance with the configuration information, a report indicative of hyper-frame number desynchronization based at least in part on satisfaction of the one or more trigger events.

2. The UE of claim 1, wherein the configuration information is indicative of a threshold quantity of instances of hyper-frame number desynchronization, and wherein satisfaction of the one or more trigger events is based at least in part on a quantity of instances of hyper-frame number desynchronization detected by the UE satisfying the threshold quantity of instances of hyper-frame number desynchronization.

3. The UE of claim 2, wherein the threshold quantity of instances of hyper-frame number desynchronization comprises a threshold quantity of consecutive instances of hyper-frame number desynchronization or a threshold quantity of instances of hyper-frame number desynchronization relative to a total quantity of packet data units.

4. The UE of claim 1, wherein, to transmit the report, the one or more processors are individually or collectively operable to execute the code to cause the UE to:
transmit the report based at least in part on expiration of a timer, wherein the timer is started based at least in part on satisfaction of the one or more trigger events.

5. The UE of claim 4, wherein the configuration information comprises an indication of a duration of the timer.

6. The UE of claim 1, wherein the report comprises an indication of a quantity of instances of hyper-frame number desynchronization, a bearer identifier associated with the hyper-frame number desynchronization, a respective sequence number associated with each instance of hyper-frame number desynchronization from the quantity of instances of hyper-frame number desynchronization, a respective counter value associated with each instance of hyper-frame number desynchronization from the quantity of instances of hyper-frame number desynchronization, a counter value associated with a last successful instance of hyper-frame number synchronization prior to reporting of the hyper-frame number desynchronization, or any combination thereof.

7. The UE of claim 1, wherein the network entity is associated with a first radio link control entity and a second radio link control entity, wherein the UE supports a first communication link associated with the first radio link control entity and a second communication link associated with the second radio link control entity in accordance with a dual connectivity configuration, and wherein, to transmit the report, the one or more processors are individually or collectively operable to execute the code to cause the UE to:
transmit the report via the first communication link based at least in part on the hyper-frame number desynchronization being associated with the first radio link control entity.

8. The UE of claim 7, wherein the report comprises an indication of an identifier associated with the first radio link control entity, a respective sequence number associated with each instance of hyper-frame number desynchronization, or both.

9. The UE of claim 7, wherein the one or more processors are individually or collectively further operable to execute the code to cause the UE to:
release the first communication link based at least in part on transmission of the report.

10. The UE of claim 1, wherein the one or more processors are individually or collectively further operable to execute the code to cause the UE to:
declare radio link failure based at least in part on the hyper-frame number desynchronization, wherein declaring radio link failure comprises transmission of the report.

11. The UE of claim 1, wherein the report is transmitted via a radio resource control message, via a medium access control (MAC) control element (CE) message, via a packet data convergence protocol control message, or any combination thereof.

12. A network entity, comprising:
one or more memories storing processor-executable code; and
one or more processors coupled with the one or more memories and individually or collectively operable to execute the code to cause the network entity to:
transmit configuration information indicative of one or more trigger events for which a user equipment (UE) is to report hyper-frame number desynchronization between the UE and the network entity; and
receive, in accordance with the configuration information, a report indicative of hyper-frame number desynchronization.

13. The network entity of claim 12, wherein the configuration information is indicative of a threshold quantity of instances of hyper-frame number desynchronization, and wherein the one or more trigger events comprise a quantity of instances of hyper-frame number desynchronization detected by the UE satisfying the threshold quantity of instances of hyper-frame number desynchronization.

14. The network entity of claim 13, wherein the threshold quantity of instances of hyper-frame number desynchronization comprises a threshold quantity of consecutive instances of hyper-frame number desynchronization or a threshold quantity of instances of hyper-frame number desynchronization relative to a total quantity of packet data units.

15. The network entity of claim 12, wherein the configuration information comprises an indication of a duration of a timer.

16. The network entity of claim 12, wherein the report comprises an indication of a quantity of instances of hyper-frame number desynchronization, a bearer identifier associated with the hyper-frame number desynchronization, a respective sequence number associated with each instance of hyper-frame number desynchronization from the quantity of instances of hyper-frame number desynchronization, a respective counter value associated with each instance of hyper-frame number desynchronization from the quantity of instances of hyper-frame number desynchronization, a counter value associated with a last successful instance of hyper-frame number synchronization prior to reporting of the hyper-frame number desynchronization, or any combination thereof.

17. The network entity of claim 12, wherein the network entity is associated with a first radio link control entity and a second radio link control entity, wherein the first radio link control entity is associated with a first communication link, wherein the second radio link control entity is associated with a second communication link, and wherein, the report is received via the first communication link based at least in part on the hyper-frame number desynchronization being associated with the first radio link control entity.

18. The network entity of claim 17, wherein the report comprises an indication of an identifier associated with the first radio link control entity, a respective sequence number associated with each instance of hyper-frame number desynchronization, or both.

19. The network entity of claim 17, wherein the one or more processors are individually or collectively further operable to execute the code to cause the network entity to:
release the first communication link based at least in part on reception of the report.

20. The network entity of claim 12, wherein the report comprises an indication of radio link failure.

21. The network entity of claim 12, wherein the report is received via a radio resource control message, via a medium access control (MAC) control element (CE) message, via a packet data convergence protocol control message, or any combination thereof.

22. A method for wireless communications at a user equipment (UE), comprising:
receiving configuration information indicative of one or more trigger events for which the UE is to report hyper-frame number desynchronization between the UE and a network entity; and
transmitting, in accordance with the configuration information, a report indicative of hyper-frame number desynchronization based at least in part on satisfaction of the one or more trigger events.

23. The method of claim 22, wherein the configuration information is indicative of a threshold quantity of instances of hyper-frame number desynchronization, and wherein satisfaction of the one or more trigger events is based at least in part on a quantity of instances of hyper-frame number desynchronization detected by the UE satisfying the threshold quantity of instances of hyper-frame number desynchronization.

24. The method of claim 23, wherein the threshold quantity of instances of hyper-frame number desynchronization comprises a threshold quantity of consecutive instances of hyper-frame number desynchronization or a threshold quantity of instances of hyper-frame number desynchronization relative to a total quantity of packet data units.

25. The method of claim 22, wherein the report comprises an indication of a quantity of instances of hyper-frame number desynchronization, a bearer identifier associated with the hyper-frame number desynchronization, a respective sequence number associated with each instance of hyper-frame number desynchronization from the quantity of instances of hyper-frame number desynchronization, a respective counter value associated with each instance of hyper-frame number desynchronization from the quantity of instances of hyper-frame number desynchronization, a counter value associated with a last successful instance of hyper-frame number synchronization prior to reporting of the hyper-frame number desynchronization, or any combination thereof.

26. A method for wireless communications at a network entity, comprising:
transmitting configuration information indicative of one or more trigger events for which a user equipment (UE) is to report hyper-frame number desynchronization between the UE and the network entity; and
receiving, in accordance with the configuration information, a report indicative of hyper-frame number desynchronization.

27. The method of claim 26, wherein the configuration information is indicative of a threshold quantity of instances of hyper-frame number desynchronization, and wherein the one or more trigger events comprise a quantity of instances of hyper-frame number desynchronization detected by the UE satisfying the threshold quantity of instances of hyper-frame number desynchronization.

28. The method of claim 27, wherein the threshold quantity of instances of hyper-frame number desynchronization comprises a threshold quantity of consecutive instances of hyper-frame number desynchronization or a threshold quantity of instances of hyper-frame number desynchronization relative to a total quantity of packet data units.

29. The method of claim 26, wherein the report comprises an indication of a quantity of instances of hyper-frame number desynchronization, a bearer identifier associated with the hyper-frame number desynchronization, a respective sequence number associated with each instance of hyper-frame number desynchronization from the quantity of instances of hyper-frame number desynchronization, a respective counter value associated with each instance of hyper-frame number desynchronization from the quantity of instances of hyper-frame number desynchronization, a counter value associated with a last successful instance of hyper-frame number synchronization prior to reporting of the hyper-frame number desynchronization, or any combination thereof.

30. The method of claim 26, wherein the network entity is associated with a first radio link control entity and a second radio link control entity, wherein the first radio link control entity is associated with a first communication link, wherein the second radio link control entity is associated with a second communication link, and wherein the report is received via the first communication link based at least in part on the hyper-frame number desynchronization being associated with the first radio link control entity.
